(19) United States
(12) Patent Application Publication
(10) Pub. No.: US 2014/0207870 A1
(43) Pub. Date: Jul. 24, 2014

(54) METHODS AND SYSTEMS FOR COMPENSATING REMOTE WORKERS

(71) Applicant: XEROX CORPORATION, Norwalk, CT (US)

(72) Inventor: Shailesh Vaya, Bangalore (IN)

(73) Assignee: XEROX CORPORATION, Norwalk, CT (US)

(21) Appl. No.: 13/746,343

(22) Filed: Jan. 22, 2013

(51) Int. Cl. H04L 29/08

(52) U.S. Cl. CPC H04L 67/10
USPC 709/205

(57) ABSTRACT

A method, a system, and a computer program product for compensating one or more remote workers. A first set of tasks including a first subset of tasks and second subset of tasks is published for remote workers. A set of responses including first subset of responses for the first subset of tasks and second subset of responses for the second subset of tasks is received. Short-listing a set of remote workers based on first subset of responses. Computing weight for the second subset of responses based on frequency of occurrence of second subset of responses inside the responses received from shortlisted set of remote workers. Compensating the shortlisted set of remote workers based on at least one of weight or performance on first subset of responses.

### TECHNICAL FIELD

The presently disclosed embodiments are related, in general, to a compensation technique for remote workers. More particularly, the presently disclosed embodiments are related to performance based compensation techniques for the remote workers.

### BACKGROUND

Organizations today are increasingly looking at unconventional ways to complete various repetitive tasks in a cost effective manner. One such approach, which has gained prominence, is crowdsourcing. By using crowdsourcing, repetitive tasks can be outsourced to multiple crowd workers in exchange for a small fee. Although crowdsourcing is gaining popularity for outsourcing tasks, one of the most vexing problems facing crowdsourcing is ensuring quality of the output delivered by crowdworkers.

### SUMMARY

According to embodiments illustrated herein, there is provided a computer implementable method for compensating one or more remote workers. The method includes publishing a first set of tasks. The first set of tasks includes a first subset of tasks and a second subset of tasks. Further, the method includes receiving a set of responses for the first set of tasks from the one or more remote workers. The set of responses includes a first subset of responses for the first subset of tasks and a second subset of responses for the second subset of tasks. Then, checking the first subset set of responses received from the one or more remote workers for the first subset of tasks. Thereafter, short-listing a first set of remote workers from the one or more remote workers based on the checking. The checking further corresponds to a comparison between number of tasks completed correctly by the one or more remote workers from the first subset of tasks with a first predefined threshold value. Further, the method includes assigning a weight to the second subset of responses received from the shortlisted first set of remote workers for the second subset of task. The weight is assigned based on the frequency of occurrence of the second subset of responses in the received set of responses. Finally, compensating the shortlisted first set of remote workers based on at least one of the weight or a predefined scheme.

According to embodiments illustrated herein, there is provided a computer implementable method for compensating one or more remote workers. The method includes publishing a first set of tasks. The first set of tasks includes a first subset of tasks and a second subset of tasks. Further, the method includes receiving a set of responses for the first set of tasks from the one or more remote workers. The set of responses includes a first subset of responses for the first subset of tasks and a second subset of responses for the second subset of tasks. Then, checking the first subset of responses received from the one or more remote workers for the first subset of tasks. Further, the method includes calculating a reputation score for the one or more remote workers based on number of tasks attempted by the one or more remote workers from the first set of tasks and the number of tasks completed correctly by the remote workers. Thereafter, short-listing a first set of remote workers from the one or more remote workers based on the checking. The checking further corresponds to a comparison between at least one of the number of tasks completed correctly by the one or more remote workers from the first subset of tasks with a first predefined threshold value or the reputation score of the one or more remote workers with a fourth predefined threshold value. Further, the method includes assigning a weight to the second subset of responses received from the shortlisted first set of remote workers for the second subset of task. The weight is assigned based on the frequency of occurrence of the second subset of responses in the received set of responses. Finally, compensating the shortlisted first set of remote workers based on at least one of the weight or a predefined scheme.

According to embodiments illustrated herein, there is provided a system for compensating one or more remote workers. The system includes a task generation module configured for generating a first set of tasks. The first set of tasks comprises a first subset of tasks and a second subset of tasks. A transceiver module configured for sending a first set of tasks to the one or more remote workers. The transceiver module is further configured for receiving a set of responses for the first set of tasks from the one or more remote workers. The set of responses comprises a first subset of responses for the first subset of tasks and a second subset of responses for the second subset of tasks. An analysis module configured for analyzing the received set of responses. The analysis module configured for analyzing the received set of responses. The analysis module further includes a checking module, a reputation-scoring module, a comparison module, and a computing module. The checking module configured for checking the first subset of responses received from the one or more remote workers for the first subset of tasks. The reputation-scoring module configured for computing a reputation score for the one or more remote workers based on number of tasks attempted by the remote workers from the first set of tasks and the number of tasks completed correctly by the remote workers. The comparison module configured for comparing at least one of the number of tasks completed correctly by the one or more remote workers from the first subset of tasks with a first predefined threshold value or the reputation score of the one or more remote workers with a fourth predefined threshold value. The computing module configured for short-listing a first set of remote workers from the one or more remote workers based on the checking and the comparison. The a computing module is further configured for assigning a weight to the second subset of responses received from the shortlisted first set of remote workers for the second subset of tasks, wherein the weight is assigned on the basis of the frequency of occurrence of the second subset of responses in the received set of responses. Finally, the system includes a compensation module configured for compensating the shortlisted first set of remote workers based on the weight and a predefined scheme.

According to embodiments illustrated herein, there is provided a computer program product for compensating one or more remote workers. The computer program product includes a computer-usable data carrier storing a computer readable program code for compensating one or more remote workers. The computer readable program code includes a program instruction means for publishing a first set of tasks. The first set of tasks comprises a first subset of tasks and a second subset of tasks. Further, the computer readable program code includes a program instruction means for receiving a set of responses for the first set of tasks from the one or more remote workers. The set of responses comprises a first subset of responses for the first subset of tasks and a second subset of responses for the second subset of tasks. Further, the computer readable program code includes a program instruction means for checking the first subset set of responses received from the one or more remote workers for the first subset of tasks. Further, the computer readable program code includes a program instruction means for short-listing a first set of remote workers from the one or more remote workers based on the checking. The checking further corresponds to a comparison between number of tasks completed correctly by the one or more remote workers from the first subset of tasks with a first predefined threshold value. Further, the computer readable program code includes a program instruction means for assigning a weight to the second subset of responses received from the shortlisted first set of remote workers for the second subset of tasks. The weight is assigned based on the frequency of occurrence of the second subset of responses in the received set of responses. Finally, the computer readable program code includes a program instruction means for compensating the shortlisted first set of remote workers based on the weight and a predefined scheme.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 illustrates a block diagram illustrating an environment in which various embodiments can be implemented;

FIG. 2 illustrates a block diagram illustrating a crowd-sourcing server, in accordance with at least one embodiment;

FIG. 3 illustrates a reputation data table, in accordance with at least one embodiment;

FIGS. 4A and 4B illustrate a flowchart for a method for performance-based compensation for one or more remote workers, in accordance with at least one embodiment; and

FIG. 5 illustrates a flowchart illustrating a method for performance and reputation based compensation for one or more remote workers, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “task” refers to a piece of work, an activity, an action, a job, an instruction or an assignment to be performed. Tasks may necessitate the involvement of one or more workers. Examples of tasks include, but are not limited to, generating a report, evaluating a document, conducting a survey, writing a code, extraction of data or translating a text.

A “remote worker” refers to a worker(s) that may perform one or more tasks, which generate data that contribute to a defined result such as proofreading a part of a digital version of an ancient text or analyzing a quantum of a large volume of data. Each crowdsourced workforce is further compensated for the contribution on the task. According to the present disclosure, the remote workers can be a satellite centre employee, a rural BPO (Business Process Outsourcing) firm employee, a home-based employee, or an internet-based employee. Hereinafter, “remote worker”, “crowdworker”, and “crowd” may be interchangeably used.

“Crowdsourcing” refers to distributing tasks by soliciting the participation of loosely defined groups of individual users. A group of users may include, for example, individuals responding to a solicitation posted on a certain website such as Amazon Mechanical Turk and Crowd Flower.

A “compensation” refers to an instruction, a command, a message, or an action for rewarding one or more remote workers. In an embodiment, the compensation can be monetary or non-monetary. The examples of compensation may include, but are not limited to, cash transfer, virtual money, reward points, recognition message, acknowledgment message, appreciation message or other such rewards.

A “reputation score” refers to a numeric value representative of the performance of a remote worker. In an embodiment, the reputation score is a function of the total number of tasks attempted by a remote worker and the total number of tasks completed successfully/unsuccessfully by the remote worker. In an embodiment, the reputation score for each remote worker is updated whenever the remote worker attempts any task.

The present disclosure introduces a method and system for compensating one or more remote workers. The one or more remote workers are registered on a crowd-sourcing platform. A crowd-sourcing server publishes a set of tasks for the one or more remote workers. The set of tasks includes a subset of gold tasks, for which correct answers are known and another subset of required tasks, for which correct responses are to be obtained from the remote workers. Further, the gold tasks and the required tasks are randomized to form the set of tasks presented to the one or more remote workers. The one or more remote workers submit their responses to the crowd-sourcing server through remote devices, which are connected to the crowd-sourcing server by a network. The crowd-sourcing server then separates the responses submitted for the gold tasks and the responses submitted for the required task from the responses received by the crowd-sourcing server. Thereafter, the crowd-sourcing server checks the responses submitted for the gold tasks by the one or more remote workers. The checking of the responses submitted for the gold tasks is performed by matching the submitted responses with the known responses of the gold tasks. A performance parameter is measured for the one or more remote workers by calculating the number of gold tasks they completed correctly. A set of remote workers are further shortlisted if their performance parameter on the gold tasks is greater than or equal to a first predefined threshold value. In case, if the performance parameter of the remote worker is less than the first predefined threshold value, they are rejected. Further, the crowd-sourcing server stops publishing the set of tasks for the one or more remote workers, when the number of the shortlisted set of remote workers becomes greater than or equal to a second predefined threshold value. Thereafter, a weight is computed for all the responses received for each task included in the required tasks. The weight is computed on the basis of frequency of occurrence of a response in the responses received from the shortlisted set of remote workers for each task included in the required tasks. An output response is selected for each task included in the required tasks if weight of any of the responses received is greater than or equal to a third predefined threshold value. In case, if the weight of all of the responses received for a particular task included in the required tasks is less than the third predefined threshold value, no output response is selected for that particular task.

Further, the shortlisted set of remote workers is rewarded with compensation. The compensation is computed on the basis of the performance parameter and total number of tasks completed by the shortlisted set of remote workers. Alternatively, the compensation can also be computed on the basis of the total number of the required tasks for which the response submitted by a remote worker is same as the selected output response. Further, the computation of compensation can also be based on the time taken by the remote workers to submit the set of tasks.

The one or more remote workers can attempt any set of tasks present at the crowd-sourcing platform according to their preferences, after completion of the registration process at the crowd-sourcing platform. A reputation score is calculated for each of the one or more remote workers registered at the crowd-sourcing platform. The reputation score is a numeric value which is computed on the basis of total number of jobs attempted and total number of jobs completed correctly/incorrectly by the one or more remote workers. Further, the disclosed embodiments can also encompass consideration of the reputation score of the one or more remote worker as a criteria for short listing the one or more remote workers for the set of tasks. The set of remote worker are shortlisted, if the reputation score of the one or more remote workers is greater than or equal to a fourth predefined threshold value. Further, the compensation for one or more remote workers can also be calculated on the basis of the reputation score of the remote workers.

Hereinafter, the gold tasks are referred as a first subset of tasks, and the required tasks are referred as a second subset of tasks.

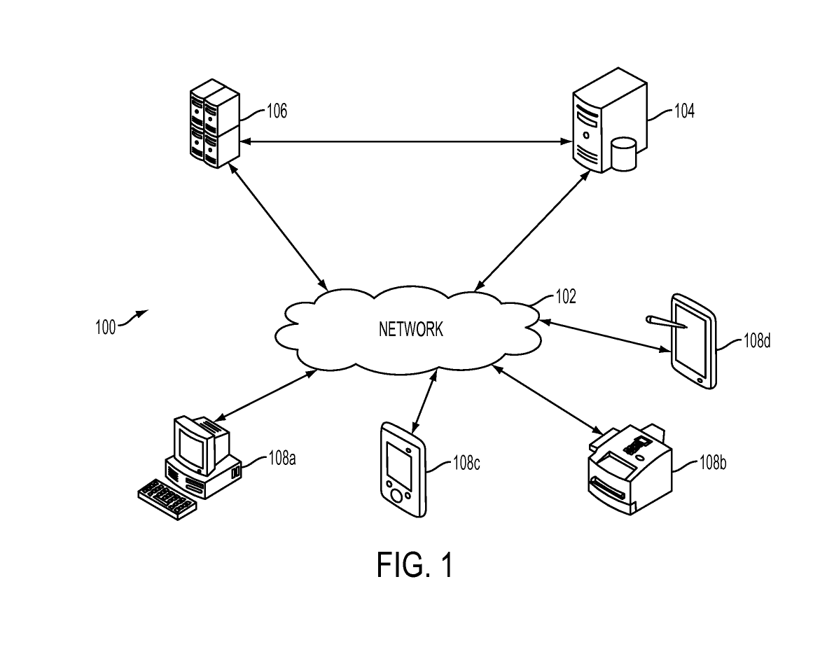

FIG. 1 is a block diagram illustrating an environment 100 in which various embodiments can be implemented. The environment 100 includes a network 102, a crowd-sourcing server 104, storage medium 106, a computing device 108a, a multi functional device 108b, a mobile phone 108c, and a personal digital assistant (PDA) 108d. The computing device 108a, the multi functional device 108b, the mobile phone 108c, and the personal digital assistant (PDA) 108d are hereinafter referred to as remote devices 108.

The network 102 is a medium through which the content and the messages flow between various components (e.g., the crowd-sourcing server 104, the storage medium 106, and the remote devices 108) of the environment 100. Examples of the network 102 include, but are not limited to, a Wireless Fidelity (WiFi) network, a Wireless Area Network (WAN), a Local Area Network (LAN), and a Metropolitan Area Network (MAN). Various devices in the environment 100 can connect to the network 102 in accordance with various wired and wireless communication protocols, such as Transmission Control Protocol and Internet Protocol (TCP/IP), User Datagram Protocol (UDP), 2G, 3G or 4 G communication protocols.

The crowd-sourcing server 104 manages a crowd-sourcing platform. In an embodiment, the crowd-sourcing server 104 manages one or more remote workers participating at the crowd-sourcing platform. Further, in an embodiment, the crowd-sourcing server 104 manages the one or more remote workers by a registration process for the one or more remote workers at the crowd-sourcing platform. The one or more remote workers register at the crowd-sourcing platform by providing their user details to the crowd-sourcing server 104. Further, in an embodiment, the crowd-sourcing server 104 generates and transmits a random set of tasks to the one or more remote workers. The crowd-sourcing server 104 receives and analyzes the set of responses submitted by the one or more remote workers. In an embodiment, the crowd-sourcing server 104 also computes a reputation score for the one or more remote workers. In another embodiment, the crowd-sourcing server 104 computes the compensation for the one or more remote workers.

In an embodiment, the storage medium 106 includes a repository of the user details of the one or more remote workers. The user details include, but are not limited to, user name, user ID, web address, or any type of basic information related to the registered one or more remote workers. In another embodiment, the storage medium 106 may also store performance related details of the one or more remote workers. The performance related details may include, but are not limited to, number of tasks attempted, number of tasks completed correctly by the remote workers, number of tasks completed incorrectly by the remote workers, reputation score of the remote workers, and other such details related to performance of the remote workers. In an embodiment, the storage medium 106 receives a request from the crowd-sourcing server 104 to extract or update the details related to the one or more remote workers. In another embodiment, the storage medium 106 is included in the crowd-sourcing server 104.

The remote device 108 is a functional unit that performs various computations such as, but not limited to, arithmetic operations and logic operations. The remote devices 108 are an interface for the remote workers to receive tasks from a crowd-sourcing server 104 and for submitting the responses back to crowd-sourcing server 104. Examples of the remote devices 108 include, but are not limited to, a computing device 108a, a personal computer (portable or desktop), a laptop, a tablet, an MFD 108b, a mobile phone 108c, a personal digital assistant (PDA) 108d, a scanner, a Smartphone, pager or any other device which has capabilities to receive and transmit the information. The remote devices 108 may be operated by an individual or may be programmed to operate automatically (i.e., timed schedule or triggered by an external event).

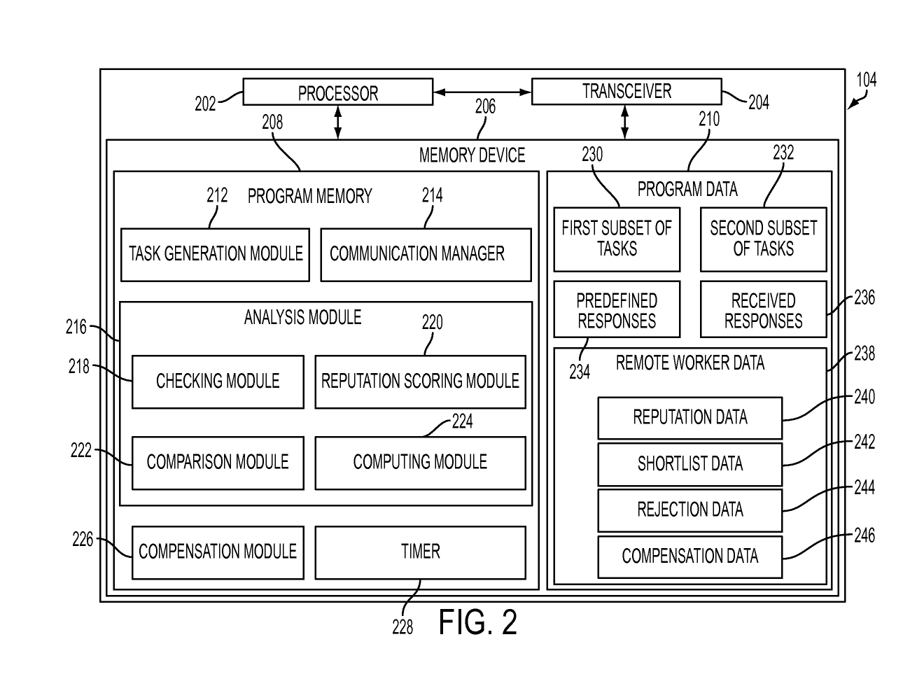

FIG. 2 is a block diagram illustrating a crowd-sourcing server 104 in accordance with at least one embodiment. The crowd-sourcing server 104 includes a processor 202, a transceiver 204, and a memory device 206.

The processor 202 is coupled to the transceiver 204 and the memory device 206. The processor 202 executes a set of instructions stored in the memory device 206. The processor 202 can be realized through a number of processor technologies known in the art. Examples of the processor 202 can be, but are not limited to, X86 processor, RISC processor, ARM processor, ASIC processor, and CISC processor.

The transceiver 204 transmits and receives messages and data to/from various components (e.g., the crowd-sourcing server 104, the storage medium 106, and the remote devices 108) of the system environment 100. Examples of the transceiver 204 can include, but are not limited to, an antenna, an Ethernet port, a USB port, or any port that can be configured to receive and transmit data from external sources. The transceiver 204 transmits and receives data/messages in accordance with various communication protocols, such as, Transmission Control Protocol and Internet Protocol (TCP/IP), USB, User Datagram Protocol (UDP), 2G, 3G and 4 G communication protocols. In an embodiment, the transceiver 204 sends a first set of tasks from the crowd-sourcing server 104 to the remote devices 108. In another embodiment, the transceiver 204 receives a set of responses from the remote devices 108.

The memory device 206 stores a set of instructions and data. Some of the commonly known memory implementations may include, but are not limited to, a random access memory (RAM), read only memory (ROM), hard disk drive (HDD), and secure digital (SD) card. The memory device 206 further includes a program memory 208 and a program data 210. The program memory 208 includes the set of instructions that are executable by the processor 202 to perform specific operations on the crowd-sourcing server 104. It will be understood by a person having ordinary skill in the art that the set of instructions stored in the program memory 208 is executed by the processor 202, in conjunction with various hardware of the crowd-sourcing server 104 to perform various operations. The program memory 208 further includes a task generation module 212, a communication manager 214, an analysis module 216, a compensation module 226, and a timer 228.

The program data 210 further includes a first subset of tasks 230, a second subset of tasks 232, predefined responses 234, received responses 236 and remote worker data 238. Further, the remote worker data 238 includes reputation data 240, shortlist data 242, rejection data 244, and compensation data 246.

A task generation module 212 generates a first set of tasks for one or more remote workers. The first set of tasks generated by the task generation module 212 includes randomly ordered union of first subset of tasks 230 and second subset of tasks 232. The first subset of tasks 230 and second subset of tasks 232 are stored inside the program data 210. In an embodiment, the task generation module 212 may generate one or more first set of tasks for the one or more remote workers, each of the one or more first set of tasks includes randomly ordered union of first subset of tasks 230 and second subset of tasks 232. In an embodiment, the first subset of tasks 230 includes at least one or more tasks for which correct response is already known and is stored as predefined responses 234 in program data 210. The first subset of tasks 230 is included in the first set of tasks to measure performance of each of the one or more remote workers. In an embodiment, the second subset of tasks 232 includes at least one or more tasks for which responses are required.

In an embodiment, the communication manager 214 receives the set of tasks from the task generation module 212 for sending the set of tasks to the one or more remote workers by transceiver 204. In an embodiment, the communication manager 214 also receives a set of responses submitted by the one or more remote workers. The communication manager 214 implements various protocol stacks such as, but not limited to, Transmission Control Protocol and Internet Protocol (TCP/IP), User Datagram Protocol (UDP), 2G, 3G, or 4 G communication protocols. The communication manager 214 transmits and receives the messages/data through the transceiver 204 in accordance with such protocol stacks. In an embodiment, the communication manager 214 stores the received set of responses as the received responses 236 in the program data 210.

The analysis module 216 analyzes the received set of responses and selects output responses for the second subset of tasks 232. In an embodiment, the analysis module 216 further includes a checking module 218, a reputation-scoring module 220, a comparison module 222, and a computing module 224.

The checking module 218 checks the received set of responses from the one or more remote workers. In an embodiment, the checking module 218 initially separates a first subset of responses submitted for the first subset of tasks 230 and a second subset of responses submitted for the second subset of tasks 232 from the received set of responses. Further, the checking module 218 matches the first subset of responses with the corresponding predefined responses 234 in the program data 210. In another embodiment, the checking module 218 checks the number of first subset of tasks completed correctly by the one or more remote workers. Further, the checking module 218 updates number of correctly completed first subset of tasks 230 by the one or more remote worker in the shortlist data 242. In an embodiment, the checking module 218 also calculates the total number of tasks attempted by the one or more remote workers from the first set of tasks.

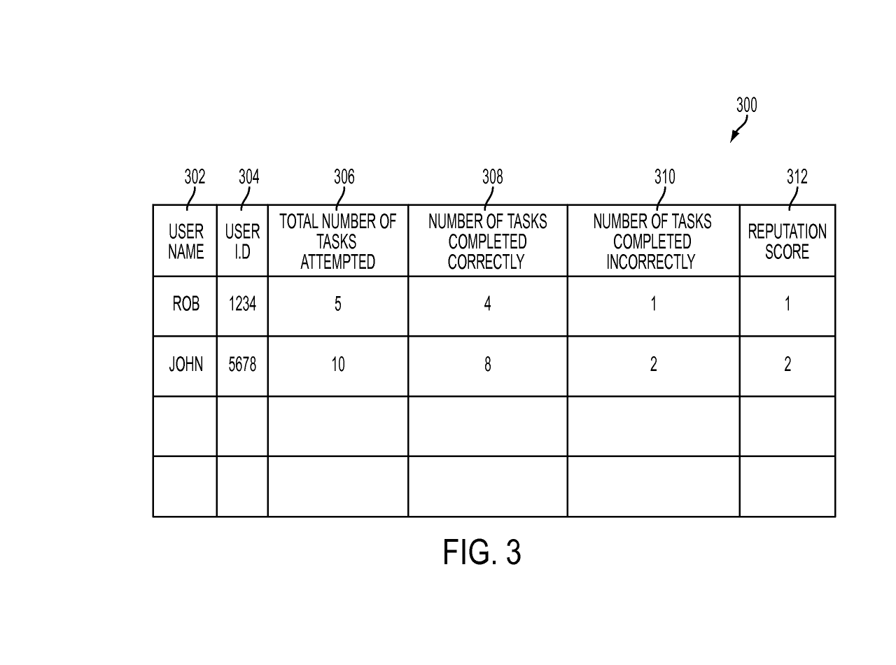

The reputation-scoring module 220 computes a reputation score for each of the one or more remote workers. The reputation score is a numeric value calculated based on a total number of first set of tasks attempted by each of the one or more remote workers and the total number of first set of tasks completed correctly by each of the one or more remote workers. In an embodiment, the reputation-scoring module 220 further updates the reputation scores of the one or more remote workers in reputation data 240 in the remote worker data 238. In another embodiment, the reputation-scoring module 220 updates the reputation score in a reputation data table 300 (as shown in FIG. 3).

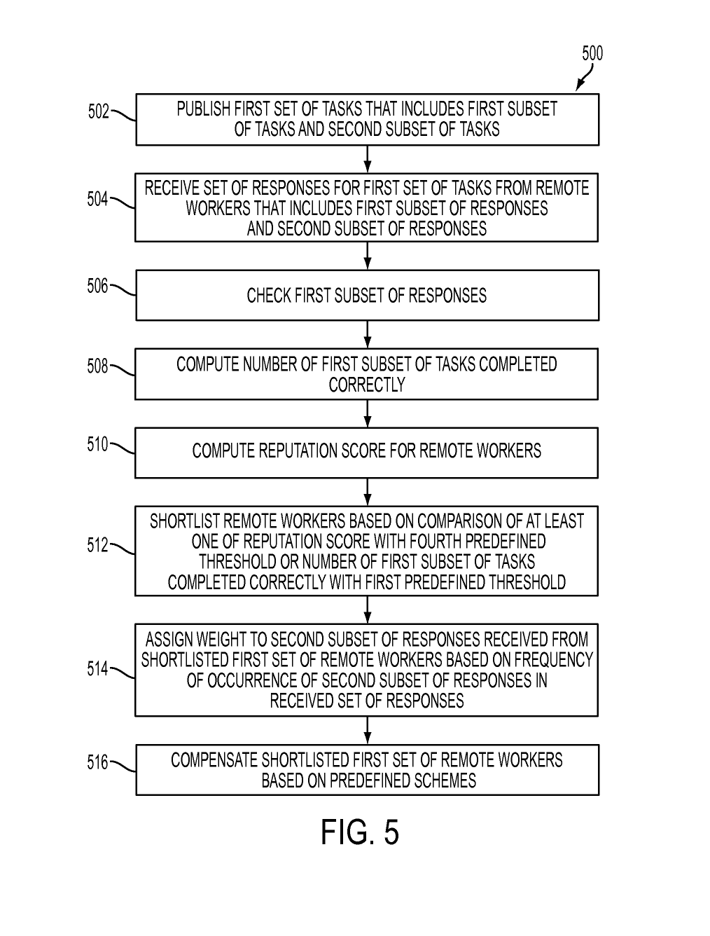

FIG. 3 depicts a reputation data table 300 in accordance with at least one embodiment. The reputation data table 300 includes a column 302 titled “user name”. The column 302 includes names of the one or more registered remote workers. The reputation data table 300 further includes a column 304 titled “user ID”. The column 304 includes identifiers of the one or more registered remote workers corresponding to their user names in column 302. The reputation data table 300 further includes a column 306 titled “total number of tasks”. The column 304 lists the total number of tasks attempted by the each of the one or more registered remote workers. The column 304 is updated by the analysis module 216 upon completion of any task by anyone of the one or more registered remote workers. The reputation data table 300 further includes a column 308 titled “number of tasks completed correctly”. The column 308 illustrates the total number of tasks for which each of the one or more remote workers has submitted correct responses. The reputation data table 300 further includes a column 310 titled “number of tasks completed incorrectly”. The column 310 illustrates the total number of tasks for which each of the one or more remote workers has submitted incorrect responses. The reputation data table 300 further includes a column 312 titled “reputation score”. The reputation score 312 is computed by reputation-scoring module 220 based on the values of column 306 (total number of tasks attempted), column 308 (total number of tasks completed correctly) and column 310 (total number of tasks completed incorrectly). Calculation of the reputation score has been explained in detail in conjunction with the explanation for FIG. 5.

Further, in an embodiment, the comparison module 222 checks a first predefined threshold condition. The comparison module 222 compares the number of first subset of tasks 230 completed correctly by the one or more remote workers with a first predefined threshold value to check the first predefined threshold condition. In an embodiment, a system administrator defines the value of a first predefined threshold for obtaining a desired level of quality assurance. The value of the first predefined threshold is programmed in the crowd-sourcing server 104 prior to the generation of the first set of tasks. In an embodiment, the comparison module 222 updates the results of the first predefined threshold condition for the one or more remote workers in the shortlist data 242.

In another embodiment, the comparison module 222 further checks a fourth predefined threshold condition for the one or more remote workers. In an embodiment, the comparison module 222 compares the reputation score for each of the one or more remote workers with a fourth predefined threshold value for checking the fourth predefined threshold condition. In an embodiment, the system administrator defines the value of a fourth predefined threshold for obtaining a desired level of quality assurance. The value of the fourth predefined threshold is programmed in the crowd-sourcing server 104 prior to the generation of the first set of tasks. In an embodiment, the comparison module 222 updates the results of the fourth predefined threshold condition for the one or more remote workers in the shortlist data 242.

The computing module 224 identifies a shortlisted set of remote workers from the one or more remote workers. In an embodiment, the computing module 224 identifies a shortlisted set of remote workers on the basis of the results of at lest one of the first predefined threshold condition or the fourth predefined threshold condition. Further, in an embodiment, the system administrator selects the basis for identification of shortlisted set of remote workers. For example, the system administrator selects both the reputation score based criteria (fourth predefined threshold condition) and first subset of task based criteria (first predefined threshold condition) as the basis for identification of the shortlisted set of remote workers, so both the criteria would be checked before short listing any remote worker. In an embodiment, the computing module 224 updates the details of the identified shortlisted set of remote workers in the shortlist data 242 stored inside the remote worker data 238.

In an embodiment, the computing module 224 computes a total number of shortlisted remote workers from the one or more remote workers. The total number of shortlisted remote workers is stored in the shortlist data 242.

Further, in an embodiment, the comparison module 222 checks a second predefined threshold condition. The comparison module 222 compares the total number of the shortlisted set of remote workers with a second predefined threshold value to check the second predefined threshold condition. In an embodiment, the system administrator defines the value of a second predefined threshold for obtaining a desired level of quality assurance. The value of the second predefined threshold is programmed in the crowd-sourcing server 104 prior to the generation of the first set of tasks. In an embodiment, the comparison module 222 updates the result of the second predefined condition for the one or more remote workers in the shortlist data 242.

Further, the computing module 224 signals the communication manager 214 regarding the allocation of the first set of tasks. In an embodiment, the computing module 224 signals the communication manager 214 to stop allocation of the first set of tasks to other one or more remote workers on the basis of the result of the second predefined threshold condition. For example, the computing module 224 stops the communication manager 214 from transmitting the first set of tasks to the other one or more remote workers, when the total number of the shortlisted set of remote workers is greater than or equal to the second predefined threshold value. In case, if the total number of shortlisted set of remote workers is less than the second predefined threshold value, the communication manager 214 keeps on transmitting the first set of tasks to the one or more remote workers by using transceiver 204.

In an embodiment, the computing module 224 assigns a weight to the second subset of responses received from the shortlisted set of remote workers. Further, in an embodiment, the computing module 224 assigns weight to the second subset of responses received for each task included in the second subset of tasks from the shortlisted set of remote workers. In an embodiment, the weight is assigned to the second subset of responses on the basis of frequency of occurrence of the second subset of responses in the set of responses received from the shortlisted set of remote workers. Further, the computation of the weight for the second subset of responses is explained later in conjunction with FIG. 5.

In an embodiment, the comparison module 222 checks a third predefined threshold condition. In an embodiment, the computing module 224 computes the weight for the second subset of responses. Further, the comparison module 222 compares the weight for the second subset of responses with a third predefined threshold value to check the third predefined threshold condition. In an embodiment, the system administrator defines the value of a second predefined threshold for obtaining a desired level of quality assurance. The value of second predefined threshold is programmed in to the crowd-sourcing server 104 prior to the generation of the first set of tasks.

In an embodiment, the computing module 224 selects the output responses for the second subset of tasks from the second subset of responses. In an embodiment, the selection of the output responses for the second subset of tasks is based on the weight of the received second subset of responses for the corresponding second subset of tasks. In an embodiment, the computing module 224 computes the weight of the received second subset of responses for the corresponding second subset of tasks. For example, in an embodiment, second subset of tasks are required tasks T, second subset of responses corresponding to required tasks T are required responses TR, weight for the required responses TR are weight W and third predefined threshold value is weight threshold ζ. So, a required response TR11 is selected as an output response for a required task T1, if the weight W11 for the required response TR11 is greater than a weight threshold ζ. In another embodiment, in case, if all the required responses from TR11 to TR1 n for the required task T1 are less than the weight threshold ζ, no output response is selected for the required task T1.

The compensation module 226 computes a compensation for the shortlisted set of remote workers. In an embodiment, the compensation module 226 computes the compensation for the shortlisted set of remote workers based on a predefined scheme. The predefined scheme for compensating the remote workers is defined by the system administrator prior to the computation of the compensation. The predefined scheme is further explained in conjunction with the explanation for FIG. 5. In an embodiment, the compensation can be monetary or non-monetary. Further, in an embodiment, if the compensation is in non-monetary form, then the compensation module 226 signals the remote workers regarding the non-monetary benefits. Examples of non-monetary benefit include, but are not limited to, sending a recognition message, giving a certificate of appreciation, giving virtual points or any other such compensations. In another embodiment, if the compensation is in monetary form, then the compensation module 226 signals a banking module (not shown) external/internal to the crowd-sourcing server 104, for transferring the monetary reward to an account of the corresponding remote worker.

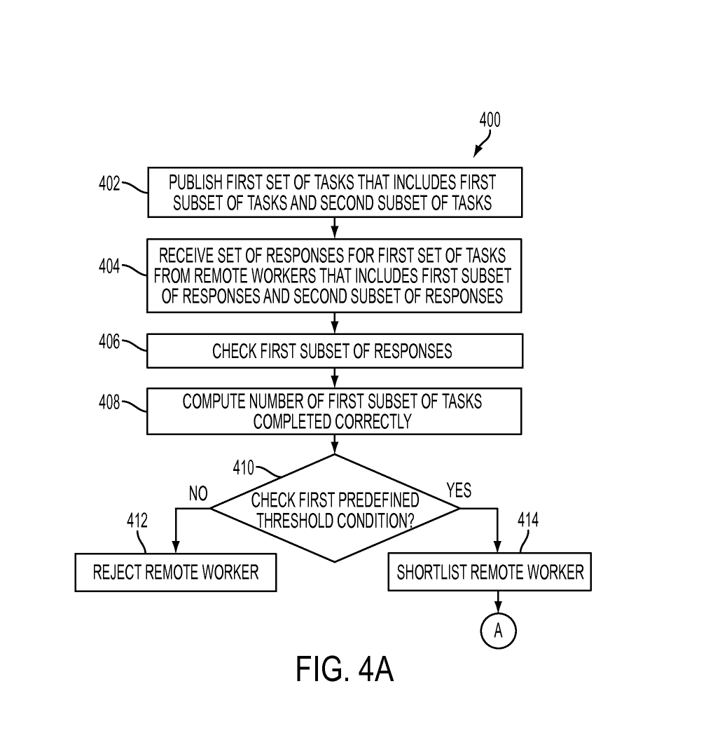

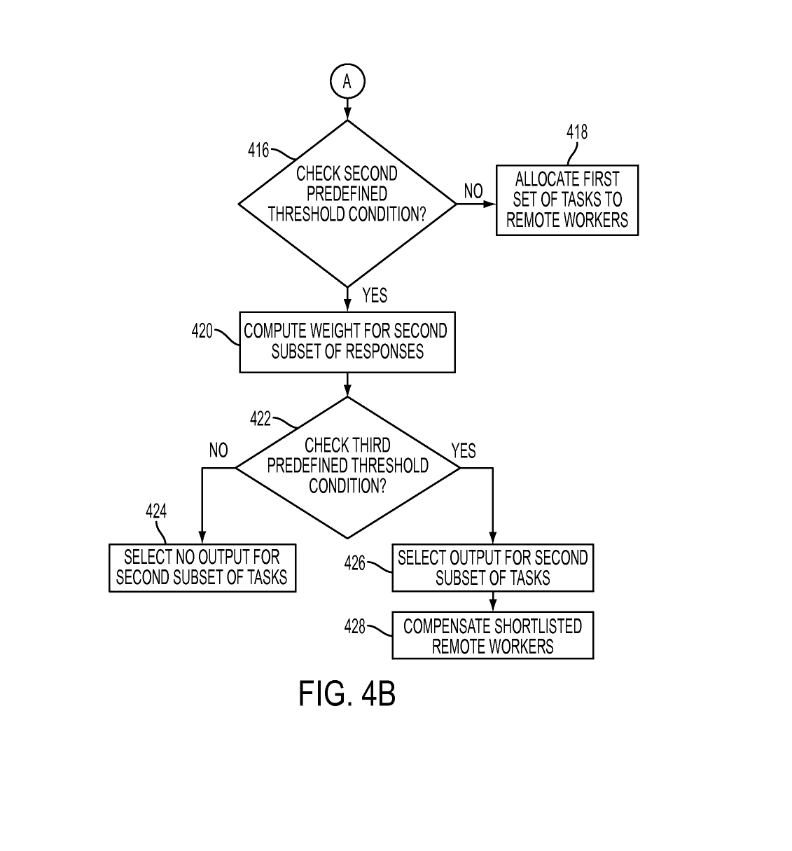

FIG. 4 is a flowchart 400 illustrating a method for performance-based compensation for one or more remote workers in accordance with at least one embodiment. The flowchart 400 is described in conjunction with FIG. 1 and FIG. 2.

At step 402, a first set of tasks is published at the remote devices 108. In an embodiment, the crowd-sourcing server 104 publishes the first set of tasks at the remote devices 108 through the crowd-sourcing platform. The one or more remote workers can access the published first set of tasks and provide the corresponding responses through the remote devices 108 connected to the network 102. Further, in an embodiment, the first set of tasks includes a first subset of tasks 230 and a second subset of tasks 232. In an embodiment, the first subset of tasks 230 includes one or more tasks, for which the correct responses are known. The correct responses for the first subset of tasks 230 are stored in the predefined responses 234. In another embodiment, the second subset of tasks 230 includes the one or more tasks, for which the correct responses are required through the crowd-sourcing platform. In an embodiment, the task generation module 212 generates the first set of tasks including randomly ordered union of first subset of tasks 230 and second subset of tasks 232. For example, a set of tasks J (corresponding to first set of tasks) includes randomly ordered union of gold tasks G and required tasks T. The first set of tasks includes randomly ordered union of first subset of tasks and second subset of tasks for performance evaluation of the one or more remote workers. The first subset of tasks 230 and second subset of tasks 232 are stored in the program data 210. Further, the task generation module 212 sends the first set of tasks to the communication manager 214, which subsequently sends it to the remote devices 108.

At step 404, a set of responses corresponding to the first set of tasks is received at the crowd-sourcing server 104. In an embodiment, the one or more remote workers submit the set of responses by the remote devices 108 through the network 102. Further, in an embodiment, the received set of responses includes first subset of responses corresponding to the first subset of tasks 230 and second subset of responses corresponding to the second subset of tasks 232. In an embodiment, the communication manager 214 receives a set of responses from the one or more remote workers, and stores them in received responses 236. In an embodiment, the checking module 218 further separates the first subset of responses and the second subset of responses from the set of received responses 236.

At step 406, a first subset of responses are checked. In an embodiment, the checking module 218 checks the first subset of responses corresponding to the first subset of tasks 230. The checking module 218 matches the first subset of responses received from the remote workers with their corresponding predefined responses 234 in the program data 210. The checking module 218 matches the first subset of responses and predefined responses 234 by using techniques known in the art such as, but not limited to, optical character recognition (OCR), mark detection, edge detection and other such techniques.

At step 408, a number of first subset of tasks completed correctly is computed. In an embodiment, the checking module 218 calculates the total number of first subset of tasks completed correctly. In an embodiment, the checking module 218 counts the total number of first subset of responses matching correctly with the predefined responses 234. In an embodiment, the number of the first subset of tasks completed correctly by the remote worker signifies a performance of the remote worker. For example, in an embodiment, a performance parameter P for the remote worker R is obtained by calculating the total number of gold tasks G completed correctly by the remote worker R. In an embodiment, the checking module 218 updates the count of the total number of correctly matching first subset of responses in shortlist data 242.

At step 410, a first predefined threshold condition is checked. In an embodiment, comparison module 222 checks the first predefined threshold condition and saves the results of the first predefined threshold condition in the shortlist data 242. Further, the first predefined threshold condition is checked by comparing the total number of the first subset of tasks 230 completed correctly by the one or more remote workers with a first predefined threshold value. In an embodiment, the first predefined threshold condition is checked for short-listing the set of remote workers, having a desired level of performance. Further, in an embodiment, the system administrator defines the value of the first predefined threshold to obtain the desired performance level. In an embodiment, the comparison module 222 retrieves the total number of first subset of tasks 230 completed correctly by the one or more remote workers from the shortlist data 242 and further compares it with the first predefined threshold value. In an embodiment, according to the results of the first predefined threshold condition, if the total number of first subset of tasks 230 completed correctly by a remote worker is less than the first predefined threshold value, then the process moves to step 412.

At step 412, the remote worker is rejected on the basis of the results of the first predefined condition. In an embodiment, the computing module 224 rejects the remote worker for the first set of tasks based on the results of the first predefined threshold condition checked by the comparison module 222. Further, in an embodiment, the remote worker is rejected, if according to the result of the first predefined threshold condition, the total number of first subset of tasks 230 completed correctly by a remote worker is less than the first predefined threshold value. In another embodiment, the computing module 224 updates a rejection data 244 with the set of rejected remote workers for the first set of tasks.

If at step 410, the total number of first subset of tasks 230 completed correctly by the remote worker is greater than or equal to the first predefined threshold value, then the process moves to step 414. At step 414, the remote worker is shortlisted on the basis of the results of the first predefined condition. In an embodiment, the computing module 224 shortlists a set of remote workers for the first set of tasks based on the results of the first predefined threshold condition checked by the comparison module 222. Further, in an embodiment, the remote worker is shortlisted, if according to the result of the first predefined threshold condition, the total number of first subset of tasks 230 completed correctly by a remote worker is less than the first predefined threshold value. In another embodiment, the computing module 224 updates the shortlist data 242 with the shortlisted set of remote workers.

At step 416, a second predefined threshold condition is checked. In an embodiment, the comparison module 222 checks the second predefined threshold condition and saves the results of the second predefined threshold condition in the shortlist data 242. The second predefined threshold condition is checked by comparing the total number of the shortlisted set of remote workers with a second predefined threshold value. In an embodiment, the second predefined threshold condition is checked for obtaining the desired level of quality assurance. Further, in an embodiment, the system administrator defines the value of the second predefined threshold to obtain the desired quality level. In an embodiment, the comparison module 222 retrieves the total number of the shortlisted set of remote workers from the shortlist data 242 and further compares it with the second predefined threshold value. In an embodiment, according to the result of the second predefined threshold condition, if the total number of the shortlisted set of remote workers is less than the second predefined threshold value, a step 418 is performed.

At step 418, a first set of tasks is allocated to the one or more remote workers. In an embodiment, the communication manager 214 keeps on transmitting the first set of tasks for the one or more remote workers, other than the shortlisted set of remote workers and rejected remote workers.

If at step 416, the total number of shortlisted set of remote workers is greater than or equal to a second predefined threshold value, a step 420 is performed. At step 420, a weight is computed for the second subset of responses received for each task included in the second subset of tasks from the shortlisted set of remote workers. In an embodiment, the computing module 224 computes the weight for a second subset of response, based on the frequency of occurrence of that second subset of response in all the second subset of responses (received corresponding to a task from the second subset of tasks). For example, in an embodiment, second subset of tasks are real tasks T, second subset of responses corresponding to real tasks T are required responses TR, shortlisted set of remote workers are shortlisted workers S and weight for the required responses TR are weight W. So, the weight W for the required response TR1 is computed on the basis of frequency of occurrence of TR1 in all the required responses TR received from all the shortlisted workers S.

At step 422, a third predefined threshold condition is checked. In an embodiment, the comparison module 222 checks the third predefined threshold condition and save the results of the third predefined threshold condition in the shortlist data 242. The third predefined threshold condition is checked by comparing the weight for the second subset of responses with a third predefined threshold value. In an embodiment, the third predefined threshold condition is checked for obtaining the desired level of quality assurance. Further, in an embodiment, the system administrator defines the value of the third predefined threshold to obtain the desired quality level. In an embodiment, according to the result of the third predefined threshold condition, if the weight for a second subset of response is less than the third predefined threshold value, a step 418 is performed.

At step 424, no output response is selected for a task from the second subset of tasks. In an embodiment, if the weight for a responses from the second subset of responses corresponding to a task from the second subset of tasks is less than the third predefined threshold value, than no output response is selected for the task.

If at step 422, weight for the second subset of responses is greater than or equal to the third predefined threshold value, a step 426 is performed. At step 426, an output response is selected from the second subset of responses for a task from the second subset of tasks 232. In an embodiment, the computing module 224 selects an output response for the second subset of tasks having a weight of the second subset of response greater than or equal to the third predefined threshold value. Further, in an embodiment, the computing module 224 selects an output response for the task from the second subset of responses based on the frequency of occurrence of the response for that task among the second subset of responses received from the one or more remote workers for that particular task.

At step 428, a compensation for shortlisted set of remote workers is computed. In an embodiment, the compensation module 226 computes the compensation for each of the shortlisted set of remote workers. The compensation for the shortlisted set of remote workers is computed based on a predefined scheme. In an embodiment, the predefined scheme for compensating the remote workers is defined by the system administrator prior to the computation of the compensation. Further, in an embodiment, the predefined scheme is based on the performance of the shortlisted set of remote workers.

In an embodiment, according to the predefined scheme, the compensation is computed for the shortlisted set of remote workers, on the basis of the total number of correctly completed first subset of tasks 230 and the total number of tasks attempted by the shortlisted set of remote workers. Further, in an embodiment, the checking module 218 calculating the total number of correctly completed first subset of tasks 230 and the total number of tasks attempted by the shortlisted set of remote workers and updates both the numbers in shortlist data 242.

In another embodiment, according to the predefined scheme, the compensation module 226 compensates the shortlisted set of remote workers, on the basis of the weight calculated by for the second subset of responses submitted by the shortlisted set of remote workers.

In another embodiment, according to a predefined scheme, the compensation module 226 computes a compensation for the shortlisted set of remote workers, on the basis of time taken by the shortlisted set of remote workers to complete the first set of tasks. In an embodiment, a timer 228 computes the time taken by the one or more remote workers in completing the first set of tasks. The timer 228 provides a timing details corresponding to each of the one or more remote workers to the compensation module 226. Further, the compensation module 226 computes the compensation for each of the one or more remote workers on the basis of the time computed by timer 228.

FIG. 5 is a flowchart 500 illustrating a method for performance and reputation based compensation for one or more remote workers in accordance with at least one embodiment. The flowchart 500 is described in conjunction with FIG. 1, FIG. 2 and FIG. 4.

Step 502 to step 508 are same as step 402 to step 408, respectively, as explained in conjunction with FIG. 4.

At step 510, a reputation score is computed for each of the one or more remote workers. In an embodiment, the reputation score is numeric value representative of a performance of the remote worker. In an embodiment, the reputation-scoring module 220 computes a reputation score for each of the one or more remote workers as explained in conjunction with FIG. 3. The reputation score is calculated on the basis of the total number of tasks attempted by the remote worker and the total number of tasks completed correctly by the remote worker. Further, in an embodiment, the reputation score for the one or more remote workers is calculated since the remote worker registers at the crowd-sourcing platform. In another embodiment, the reputation-scoring module 220 updates the reputation score for the remote worker after completion of every task attempted by the remote worker. In an embodiment, the reputation-scoring module 220 utilizes the following equations to compute the semantic score:

R(x,y)=log c(y−d(x−y))+e (1)

where,

x is an total number of tasks attempted by the remote worker;

y is a total number of tasks successfully solved by the remote worker;

c, e is a positive constants;

d is a positive constant indicative of the relative penalty induced by the system on the remote worker for completing a task incorrectly.

In an embodiment, if the remote worker is newly registered at the crowd-sourcing platform, the reputation score assigned to the remote worker would be zero. In an embodiment, the reputation score calculated by reputation-scoring module 220 is dependent upon both the total number of tasks correctly performed by the remote workers and the total number of tasks incorrectly performed by the remote workers. Hence, the reputation score decreases with increase in the total number of incorrectly performed tasks and the reputation score increases with decrease in the total number of correctly performed tasks by the remote worker. The reputation-scoring module 220 enhances the system performance by reprimanding the remote workers submitting incorrect responses.

At step 512, a set of remote workers are shortlisted based on the comparison between at least one of a reputation score with a fourth predefined threshold value or a total number of the first subset of tasks 230 completed correctly by the one or more remote workers with a first predefined threshold value. In an embodiment, the system administrator selects one or both of the conditions of comparison for short-listing a set of remote workers. In an embodiment, the comparison module 222 compares one or both the conditions of comparison depending upon the preferences selected by the system administrator.

At step 514, a weight is computed for each of the second subset of responses. In an embodiment, the computing module 224 computes the weight for each of the second subset of responses received from the shortlisted set of remote workers based on the frequency of occurrence of the second subset of responses in the received set of responses. This step is corresponding to step 420.

At step 516, the compensation for shortlisted set of remote workers is computed. In an embodiment, the compensation module 226 computes the compensation for each of the shortlisted set of remote workers. Further, in an embodiment, the computation of the compensation for one or more of the shortlisted set of remote workers is based on the predefined scheme as explained in conjunction with FIG. 4. In another embodiment, according to the predefined scheme, the compensation for the shortlisted set of remote workers may be computed on the basis of the reputation score of the shortlisted set of remote workers. This step is corresponding to step 428.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as, steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, a fair and robust compensation technique for the one or more remote workers. The disclosed compensation technique is constituting of a fair performance estimation method which takes both the past and current performance of the worker into consideration. The fair performance estimation methodology facilitates in determination of efficiency of the workers. The efficiency of the workers is directly correlated to the quality of the responses received from the workers. Further, the disclosed compensation technique considers a threshold level of efficiency for the workers, which facilitates in assuring high quality responses.

Various embodiments of the disclosure titled “methods and systems for compensating remote workers” have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method implemented on a computing device for compensating one or more remote workers, the method comprising:
publishing a first set of tasks, wherein the first set of tasks comprises a first subset of tasks and a second subset of tasks;
receiving a set of responses for the first set of tasks from the one or more remote workers, wherein the set of responses comprises a first subset of responses for the first subset of tasks and a second subset of responses for the second subset of tasks;
checking the first subset set of responses received from the one or more remote workers for the first subset of tasks;
short-listing a first set of remote workers from the one or more remote workers on the basis of the checking, wherein the checking further corresponds to a comparison between number of tasks completed correctly by the one or more remote workers from the first subset of tasks with a first predefined threshold value;
assigning a weight to the second subset of responses received from the shortlisted first set of remote workers for the second subset of tasks, wherein the weight is assigned on the basis of the frequency of occurrence of the second subset of responses in the received set of responses; and
compensating the shortlisted first set of remote workers on the basis of at least one of the weight or a predefined scheme.

2. The method of claim 1, wherein the first set of tasks comprises a randomly ordered union of the first subset of tasks and the second subset of tasks.

3. The method of claim 1, wherein the first subset of tasks corresponds to the tasks having a set of predefined responses.

4. The method of claim 3, wherein checking the first subset of responses further corresponds to calculating number of the first subset of responses matched correctly with the set of predefined solution for the one or more remote workers.

5. The method of claim 1 further comprising comparing number of the shortlisted first set of remote workers with a second predefined threshold value.

6. The method of claim 5, wherein the comparison further corresponds to reallocate the first set of tasks to the one or more remote workers on the basis of a predefined condition.

7. The method of claim 1 further comprising comparing the weight of the second subset of responses with a third predefined threshold value.

8. The method of claim 7, wherein comparing the weight of the second subset of responses with the third predefined threshold value further corresponds to selection of an output response from the second subset of responses.

9. The method of claim 1, wherein the predefined scheme corresponds to compensating the shortlisted first set of remote workers based on the checking.

10. The method of claim 9, wherein the predefined scheme corresponds to compensating the shortlisted first set of remote workers based on the number of tasks completed by the remote workers.

11. The method of claim 9, wherein the predefined scheme corresponds to compensating the shortlisted first set of remote workers based on a time taken by the shortlisted first set of remote workers for submitting the set of responses for the first set of tasks.

12. The method of claim 1, wherein the predefined scheme corresponds to compensating the shortlisted first set of remote workers based on the weight of the second subset of responses.

13. A method implemented on a computing device for compensating one or more remote workers, the method comprising:
publishing a first set of tasks, wherein the first set of tasks comprises a first subset of tasks and a second subset of tasks;
receiving a set of responses for the first set of tasks from the one or more remote workers, wherein the set of responses comprises a first subset of responses for the first subset of tasks and a second subset of responses for the second subset of tasks;
checking the first subset set of responses received from the one or more remote workers for the first subset of tasks;
calculating a reputation score for the one or more remote workers on the basis of number of tasks attempted by the one or more remote workers from the first set of tasks and the number of tasks completed correctly by the remote workers;
short-listing a first set of remote workers from the one or more remote workers on the basis of the checking, wherein the checking further corresponds to a comparison between at least one of the number of tasks completed correctly by the one or more remote workers from the first subset of tasks with a first predefined threshold value or the reputation score of the one or more remote workers with a fourth predefined threshold value;
assigning a weight to the second subset of responses received from the shortlisted first set of remote workers for the second subset of tasks, wherein the weight is assigned on the basis of the frequency of occurrence of the second subset of responses in the received set of responses; and
compensating the shortlisted first set of remote workers on the basis of the weight and a predefined scheme.

14. The method of claim 13, wherein the reputation score for the one or more remote worker is updated with the number of tasks attempted by the remote workers.

15. The method of claim 13, wherein the reputation score is further updated on the basis of the number of tasks incorrectly solved.

16. The method of claim 13, wherein the fourth predefined threshold is decreased when number of the shortlisted first set of remote workers is less then a second predefined threshold value.

17. The method of claim 13, wherein the predefined scheme corresponds to compensating the shortlisted first set of remote workers based on the reputation score of the shortlisted first set of remote workers.

18. A system for compensating one or more remote workers, the system comprising:
a task generation module configured for generating a first set of tasks, wherein the first set of tasks comprises a first subset of tasks and a second subset of tasks;
a transceiver module configured for:
sending a first set of tasks to the one or more remote workers;
receiving a set of responses for the first set of tasks from the one or more remote workers, wherein the set of responses comprises a first subset of responses for the first subset of tasks and a second subset of responses for the second subset of tasks;
an analysis module configured for analyzing the received set of responses, wherein the analysis module further comprises:
a checking module configured for checking the first subset of responses received from the one or more remote workers for the first subset of tasks;
a reputation scoring module configured for computing a reputation score for the one or more remote workers on the basis of number of tasks attempted by the remote workers from the first set of tasks and the number of tasks completed correctly by the remote workers;
a comparison module configured for comparing at least one of the number of tasks completed correctly by the one or more remote workers from the first subset of tasks with a first predefined threshold value or the reputation score of the one or more remote workers with a fourth predefined threshold value;
a computing module configured for:
short-listing a first set of remote workers from the one or more remote workers on the basis of the checking and the comparison;
assigning a weight to the second subset of responses received from the shortlisted first set of remote workers for the second subset of tasks, wherein the weight is assigned on the basis of the frequency of occurrence of the second subset of responses in the received set of responses; and
a compensation module configured for compensating the shortlisted first set of remote workers on the basis of the weight and a predefined scheme.

19. The system of claim 18, wherein the task generation module is further configured for randomly ordering union of the first subset of tasks and second subset of tasks inside the first set of tasks.

20. The system of claim 18, wherein the computing module is further configured for:
calculating the number of tasks completed correctly by the one or more remote workers from the first subset of tasks and number of the shortlisted first set of remote workers; and
selecting an output response for the second subset of tasks on the basis of the weight assigned to the second subset of responses.

21. The system of claim 18, wherein the comparison module is further configured for comparing the weight of the second subset of responses with a third predefined threshold value.

22. The system of claim 18 further comprises a timer for computing the time taken by the shortlisted first set of remote workers for submitting the set of responses for the first set of tasks.

23. A computer program product for use with a computer, the computer program product comprising a computer-usable data carrier storing a computer readable program code embodied therein for compensating one or more remote workers, the computer readable program code comprising:
a program instruction means for publishing a first set of tasks, wherein the first set of tasks comprises a first subset of tasks and a second subset of tasks;
a program instruction means for receiving a set of responses for the first set of tasks from the one or more remote workers, wherein the set of responses comprises a first subset of responses for the first subset of tasks and a second subset of response for the second subset of tasks;
a program instruction means for checking the first subset set of responses received from the one or more remote workers for the first subset of tasks;
a program instruction means for short-listing a first set of remote workers from the one or more remote workers on the basis of the checking, wherein the checking further corresponds to a comparison between number of tasks completed correctly by the one or more remote workers from the first subset of tasks with a first predefined threshold value;
a program instruction means for assigning a weight to the second subset of responses received from the shortlisted first set of remote workers for the second subset of tasks, wherein the weight is assigned on the basis of the frequency of occurrence of the second subset of responses in the received set of responses; and
a program instruction means for compensating the shortlisted first set of remote workers on the basis of the weight and a predefined scheme.

24. A computer program product for use with a computer, the computer program product comprising a computer-usable data carrier storing a computer readable program code embodied therein for compensating one or more remote workers, the computer readable program code comprising:
a program instruction means for publishing a first set of tasks, wherein the first set of tasks comprises a first subset of tasks and a second subset of tasks;
a program instruction means for receiving a set of responses for the first set of tasks from the one or more remote workers, wherein the set of responses comprises a first subset of responses for the first subset of tasks and a second subset of responses for the second subset of tasks;
a program instruction means for checking the first subset set of responses received from the one or more remote workers for the first subset of tasks;
a program instruction means for calculating a reputation score for the one or more remote workers on the basis of number of tasks attempted by the remote workers from the first set of tasks and the number of tasks completed correctly by the remote workers;
a program instruction means for short-listing a first set of remote workers from the one or more remote workers on the basis of the checking, wherein the checking further corresponds to a comparison between at least one of the number of tasks completed correctly by the one or more remote workers from the first subset of tasks with a first predefined threshold value or the reputation score of the one or more remote workers with a fourth predefined threshold value;
a program instruction means for assigning a weight to the second subset of responses received from the shortlisted first set of remote workers for the second subset of tasks, wherein the weight is assigned on the basis of the frequency of occurrence of the second subset of responses in the received set of responses; and
a program instruction means for compensating the shortlisted first set of remote workers on the basis of the weight and a predefined scheme.
